(19) United States
(12) Patent Application Publication
(10) Pub. No.: US 2016/0261518 A1
(43) Pub. Date: Sep. 8, 2016

(54) MANAGMENT SYSTEM OF THE RESOURCES OF AN ACCESS CONNECTION PROVIDED BY AN ENTERPRISE

(71) Applicants: Giovanni GUERRI, Reggio Emilia (IT); Nicola IOTTI, Bibbiano (IT)

(72) Inventors: Giovanni GUERRI, Reggio Emilia (IT); Nicola IOTTI, Bibbiano (IT)

(21) Appl. No.: 14/636,107

(22) Filed: Mar. 2, 2015

(51) Int. Cl. H04L 12/911; G06F 9/455; H04L 29/08

(52) U.S. Cl. CPC H04L 47/70; H04L 67/02; H04L 67/06; G06F 9/45558; H04L 67/141; G06F 2009/4557; G06F 2009/45595

(57) ABSTRACT

the present invention relates to system of electronic apparatuses and devices for the management of an access connection, as internet and/or intranet connection, provided by an enterprise as a chain of stores, for example based on the specific services enquires in a specific moment, contrary to the statistic approach of the communication provider service company

### FIELD OF INVENTION

The present invention relates to the field of management system of the resources of electronic devices. More particularly, the present invention relates to system of electronic apparatuses and devices for the management of an access connection, including but not limited to wireless access, as internet and/or intranet connection, provided by an enterprise as a chain of stores, for example.

### BACKGROUND OF THE INVENTION

Free Wi-Fi internet connection is a way to attract clients in a store, restaurant etc. The Wi-Fi internet connections available are all via a communication service provider company as AT&T, Verizon, Vodafone, etc.

The communication service provider companies of the internet bandwidth quantity and traffic priority policies allocates the quantity of the internet bandwidth on the basis of the statistical use of the internet bandwidth, mostly considering the geographical area, the hours of the day and the day of the week or on the basis of statically configured policies, considering the type of traffic transmitted. Therefore it happens that this policy devotes too much or not enough quantity of the internet bandwidth or traffic priority in respect to the needs of it in certain area in a certain moment.

This policy does not combine very well with the internet bandwidth needs required by the stores, restaurants and chain of stores supplying the information and details of their products and/or services and/or custom care and sale assistance services to the clients mobile communication devices provided via Wi-Fi internet connection. For better understanding the invention, the information and details of their products and/or services and/or custom care and sale assistance services to the clients mobile communication devices via Wi-Fi internet connection or other connection, as intranet, are named in short “interactive marketing services”.

In the case of those services, the clients mobile communication devices have to receive the signals of the interactive marketing services at the appropriate speed and clarity.

Those characteristics cannot be guaranteed by the communication service provider companies due to their policy on internet bandwidth quantity or traffic priority mentioned above but for having a useful interactive marketing services a solution have has to be found.

### DESCRIPTION OF THE INVENTION

The present invention is directed to apparatuses and system for managing an internet or internet and intranet access connection, including but not limited to wireless access, provided by an enterprise as stores, restaurants, chain of stores for example. More particularly the apparatuses and the system of this invention manage an internet or internet and intranet access connection provided by said enterprises in order to have a good connection with the clients' mobile communication devices for querying and receiving interactive marketing services.

Before describing the present invention in detail, it is to be understood that the terminology used herein for the purpose of describing this invention is not intended to be limiting. The plural forms include the singular and vice versa unless the content clearly dictates otherwise.

The system of the present invention manages an access connection alternatively to internet or to internet and intranet provided by an enterprise as above qualified (enterprise network).

The management of the enterprise network of the present invention is based on the specific services enquires in a specific moment, contrary to the statistic or statically configured approach of the communication provider service company. It is carried out by a system of electronic apparatuses comprising a first electronic device for a mobile communication device, as a smart phone for example, for identifying and connecting a mobile communication device, as a client mobile communication device, to the enterprise network within a specific area and for transmitting and receiving signals form specific sources as the enterprise network terminal gateway, better described below and/or a identified data center (I+C device). The I+C device is aboard the client mobile communication device (I+C mobile communication device). The first electronic device can be an electronic hardware but also a software.

In the system of electronic apparatuses of the present invention, the I+C mobile communication device can be identified and connected to the enterprise network by an electronic apparatus which can also be programmed and equipped to store, select and transmit multimedia content files to the I+C mobile communication device based on the I+C mobile communication device enquiries and to connect to at least one interactive in house and/or outsource service (enterprise network terminal gateway). For better explaining the invention, it is to be clarified that: (i) multimedia content files can be, but the invention is not limited to, multimedia files of the information and details of products and/or services offered by the enterprise providing the enterprise network; (ii) interactive in house and/or outsource service can be, but the invention is not limited to, custom care and sale assistance services provided by virtual or remote custom care and/or sale assistance personnel. The multimedia content file mentioned under (i) and the interactive services, mentioned under (ii), shall be named hereinafter as “service” when the context so requires.

The system of electronic apparatuses of the present invention also comprise at least one data center that can be programmed and equipped for having the I+C mobile communication device identified and connected to the enterprise network. The data center can be also programmed and equipped to store, select and transmit the multimedia content files to the I+C mobile communication device based on the I+C mobile communication device enquiries and to connect to at least one interactive in house and/or outsource service.

Alternatively or concurrently, the enterprise network terminal gateway and the data center are programmed and equipped to store, select and transmit multimedia content files to the I+C mobile communication device based on the I+C mobile communication device enquiry and to connect to at least one interactive in house and/or outsource service.

Alternatively the enterprise network terminal gateway and the data center are also programmed and equipped:
for receiving in a dynamic and continuous way the signals representing the service enquiries from the I+C mobile communication devices connected to the enterprise network and the information regarding the enterprise network resource available (Collection of the Enquiry and Information). For better explaining the invention, it is to be clarified that the term “resource” means and includes the bandwidth of the network, the cpu, and the memory of the enterprise network terminal gateway that is available;
for evaluating in a dynamic and continuous way the number of the signals representing the service enquires and categorizing, based on a pre-categorization, each service enquired by each I+C mobile communication device connected to the enterprise network, comparing them to the enterprise network resource available (Evaluation of the Configuration Services).

Therefore, the enterprise network terminal gateway and the data center are programmed and equipped alternatively as follow:
(a) the enterprise network terminal gateway is programmed and equipped for:
   receiving in a dynamic and continuous way the service enquiry signals from the I+C mobile communication devices connected to the enterprise network and the information regarding the enterprise network resource available (Collection of the Enquiry and Information) and for evaluating in a dynamic and continuous way the number of the service enquires and categorizing each service enquired by each I+C mobile communication device connected to the enterprise network compared to the enterprise network resource available (Evaluation of the Configuration Services); or
(b) the data center is programmed and equipped for the Collection of the Enquiry and Information and for the Evaluation of the Configuration Services; or
(c) the data center is programmed and equipped for the Collection of the Enquiry and Information and the enterprise network terminal gateway is programmed and equipped for the Evaluation of the Configuration Services; or
(d) the enterprise network terminal gateway is programmed and equipped for the Collection of the Enquiry and Information and the data center is programmed and equipped for the Evaluation of the Configuration Services.

The enterprise network terminal gateway has a processor to control in a dynamic and continuous way at least one of the following network configurations: quality of services; the bandwidth; the cpu and the memory management policies based on the Evaluation of the Configuration Service for a better management of the enterprise network. The management of the enterprise network is based on the specific services enquires in a specific moment contrary to the statistic approach of the communication provider service company.

In one embodiment, the enterprise network terminal gateway is programmed and equipped to create, control, configure and delete virtual machines and virtual network functions in a dynamic, temporary and continuous way modifying the configuration services of the enterprise network terminal gateway based on the Evaluation of the Configuration Services.

the enterprise network terminal gateway is also programmed and equipped with electronic tools to transfer at least one multimedia content files to the data center or retrieve at least one multimedia content files from the data center based on the Evaluation of the Configuration Services. It can also be programmed to modulate the enterprise network resource based on the Evaluation of the Configuration Services for the appropriate transmission and/or of multimedia content files and/or for the appropriate connection to at least one interactive in house and/or outsource services to the I+C mobile communication device based on the I+C mobile communication device enquiry.

In another embodiment, it is the data center that is programmed and equipped to create, control, configure and delete virtual machines and virtual network functions in a dynamic, temporary and continuous way modifying the configuration of the enterprise network terminal gateway based on the Evaluation of the Configuration

Services.

The data center is also programmed and equipped to transfer at least one multimedia content files to the enterprise network terminal gateway or retrieve at least one multimedia content files from the enterprise network terminal gateway based on the Evaluation of the Configuration Services. It can also be programmed and equipped to modulate the enterprise network resource based on the Evaluation of the Configuration Services for the appropriate transmission of multimedia content files and/or for the appropriate connection to at least one interactive in house and/or outsource services to the I+C mobile communication device based on the I+C mobile communication device enquiry.

### DESCRIPTION OF THE DRAWING

FIG. 1 illustrates the connection of each electronic apparatus of the system of the present invention to manage the enterprise network of the present invention.

FIG. 1 shows the enterprise network (1) to be manage by the system of electronic apparatus comprising a first electronic device, named in short I+C device (2), for a mobile communication device, as a smart phone for example. The I+C device (2) identifies and connect the mobile communication device to the enterprise network (1) within a specific area and for transmitting and receiving signals form the enterprise network terminal gateway(4) and/or the data center (5).

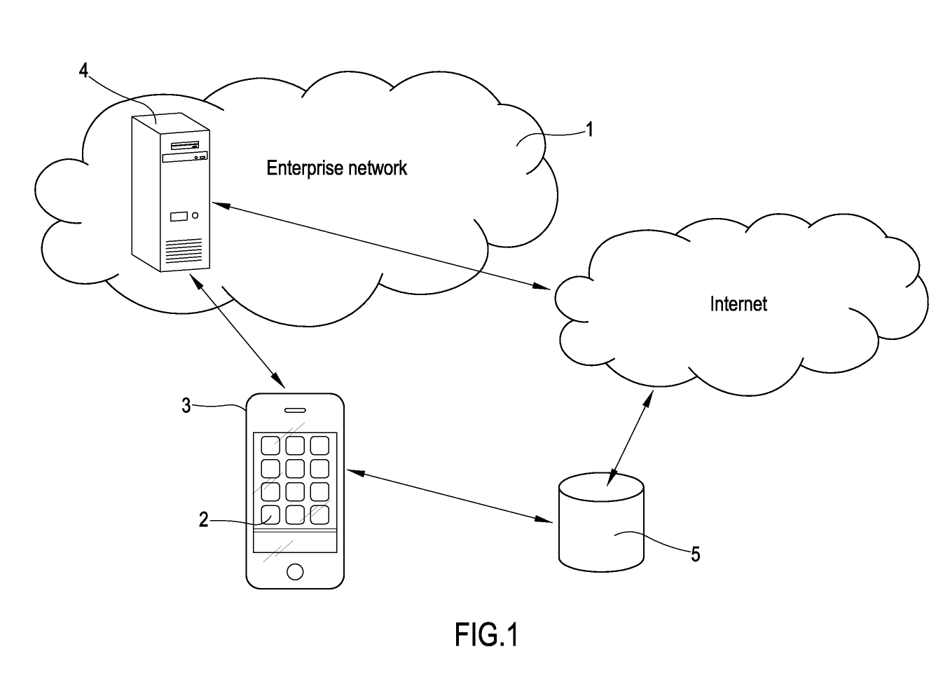

What is claimed is:

1. A management system of the resources of an access connection provided by an enterprise (enterprise network) comprising:
a first electronic device for a mobile communication device for identifying and connecting a mobile communication device to the enterprise network within a specific area for transmitting and receiving signals (I+C device) from specific sources, a mobile communication device having the I+C device (I+C mobile communication device);
an electronic apparatus programmed and equipped to identify and connect the I+C mobile communication device to the enterprise network and to store, select, transmit multimedia content files to the I+C mobile communication device based on the I+C mobile communication device enquiries and to connect to at least one interactive in house and/or outsource service (enterprise network terminal gateway);
at least one data center; and
alternatively or concurrently:
the enterprise network terminal gateway and the data center are programmed and equipped to store, select, transmit multimedia content files to the I+C mobile communication device based on the I+C mobile communication device enquiries and to connect to at least one interactive in house and/or outsource service wherein alternatively:
the enterprise network terminal gateway is programmed and equipped for:
receiving in a dynamic and continuous way the signals representing service enquiries from the I+C mobile communication devices connected to the enterprise network, the information regarding the enterprise network resource available (Collection of the Enquiry and Information) and evaluating in a dynamic and continuous way the number of the signals representing the service enquiries and categorizing, based on a pre-categorization, each service enquired by each I+C mobile communication device connected to the enterprise network comparing them to the enterprise network resource available (Evaluation of the Configuration Services); or
the data center is programmed and equipped for the Collection of the Enquiry and Information and for the Evaluation of the Configuration Services; or
the data center is programmed and equipped for the Collection of the Enquiry and Information and the enterprise network terminal gateway is equipped for the Evaluation of the Configuration Services; or
the enterprise network terminal gateway is programmed and equipped for the Collection of the Enquiry and Information and the data center is programmed and equipped for the Evaluation of the Configuration Services.

2. A management system in accordance to claim 1 wherein the enterprise network terminal gateway has a processor to control in a dynamic and continuous way at least one of the following network configurations: quality of services; the bandwidth; the cpu and the memory management policies based on the Evaluation of the Configuration Services.

3. A system in accordance to claim 1 wherein the enterprise network terminal gateway is programmed and equipped to create, control, configure and delete virtual machines and virtual network functions in a dynamic, temporary and continuous way modifying the configuration services of the enterprise network terminal gateway based on the Evaluation of the Configuration Services.

4. A system in accordance to claim 1 wherein the data center is programmed and equipped to create, control, configure and delete virtual machines and virtual network functions in a dynamic, temporary and continuous way modifying the configuration of the enterprise network terminal gateway based on the Evaluation of the Configuration Services.

5. A system in accordance to claims 1 wherein the enterprise network terminal gateway is programmed and equipped with electronic tools to transfer at least one multimedia content files to the data center or retrieve at least one multimedia content files form the data center based on the Evaluation of the Configuration Services.

6. A system in accordance to 1 wherein the data center is programmed and equipped to transfer at least one multimedia content files to the enterprise network terminal gateway or retrieve at least one multimedia content files from the enterprise network terminal gateway based on the Evaluation of the Configuration Services

7. A system in accordance to claims 1 and 4 or 1 and 6 or 1, 4 and 6 wherein the data center is programmed and equipped to modulate the enterprise network resource based on the Evaluation of the Configuration Services for the appropriate transmission of multimedia content files and/or for the appropriate connection to at least one interactive in house and/or outsource services to the I+C mobile communication device based on the I+C mobile communication device enquiries

8. A system in accordance to claims, 1 and 3 or 1 and 5 or 1, 3 and 5 wherein the enterprise network terminal gateway is programmed and equipped with electronic tools to modulate the enterprise network resources based on Evaluation of the Configuration Services for the appropriate transmission of multimedia content files and/or the appropriate connection to at least one interactive in house and/or outsource services to the I+C mobile communication device based on the I+C mobile communication device enquiry.
